(19) United States
(12) Patent Application Publication
(10) Pub. No.: US 2026/0098772 A1
(43) Pub. Date: Apr. 9, 2026

(54) Sensor Assembly for an Actuation Device of a Vehicle and Vehicle

(71) Applicant: Bayerische Motoren Werke Aktiengesellschaft, Muenchen (DE)

(72) Inventor: Johannes BRUCKMAIER, Mettenheim (DE)

(21) Appl. No.: 19/114,133

(22) PCT Filed: Aug. 25, 2023
(86) PCT No.: PCT/EP2023/073375

§ 371 Date: Mar. 21, 2025

(30) Foreign Application Priority Data
Sep. 23, 2022 (DE) 10 2022 124 549.7

(51) Int. Cl. G01L 5/22

(52) U.S. Cl. CPC G01L 5/225; G01L 5/221

(57) ABSTRACT

A sensor assembly for an actuation device of a vehicle includes a control device and a first sensor group with a first and a second force sensor. At least one of the force sensors is mechanically coupled to the actuation device, and at least one is electrically coupled to the control device. Each force sensor is designed to detect a force acting on the respective force sensor regardless of the other force sensors. The control device determines a force exerted by the actuation device on the force sensor based on a measurement signal received via the at least one force sensor. The force sensors of the first sensor group are arranged on top of one another or next to one another relative to the actuation device.

### BACKGROUND AND SUMMARY

The present disclosure relates to a sensor assembly for an actuation device of a vehicle and a vehicle.

Modern vehicles have electrical or electronics-based braking or acceleration input devices. The pedals are configured here as so-called brake-by-wire or throttle-by-wire systems (BBW/TBW systems). This means that a classic mechanical connection is not provided between the respective pedal and the braking devices or the drive device of the vehicle. Rather, the respective driver input is detected by sensors and electrically transmitted to respective control devices. Furthermore, there are approaches for steer-by-wire steering systems without mechanical connection. On the one hand, installation space can thus be saved and, on the other hand, a weight savings can be achieved, so that the operating efficiency of the vehicle is improved.

In known BBW or TBW systems, the input commands of the driver are detected by hydraulically based pickups. However, hydraulically based pickups have a comparatively high intrinsic weight and require a comparatively large amount of installation space. They therefore have a disadvantageous effect on the operating efficiency of the vehicle. In addition, they carry the risk of a leak, in the case of which hydraulic fluid escapes. To create a redundancy, multiple hydraulically based pickups are therefore typically provided, by which the operating efficiency of the vehicle is additionally disadvantageously influenced. In steering systems, the driver intention detection, thus the steering angle specification, is typically effectuated via rotational angle sensors.

The present disclosure is therefore based on an object of eliminating or at least reducing the disadvantages of the prior art. In particular, it is desirable to create a possibility for detecting input commands of a driver which enables an installation space reduction and a weight savings, so that the operating efficiency of the vehicle is improved.

This object is achieved by the subject matter of the present disclosure. Advantageous embodiments are also specified in the following description, which can represent aspects of the present disclosure as such or in (sub-)combination.

According to one aspect, a sensor assembly for an actuation device, in particular a pedal, of a vehicle is provided. The sensor assembly comprises at least one control device and a first sensor group having a first force sensor and a second force sensor. At least one of the force sensors of the first sensor group is mechanically coupled with the actuation device and at least one of the force sensors of the first sensor group is electrically or electronically coupled with the control device. Each force sensor is configured to detect a force acting on the respective force sensor independently of other force sensors of the sensor assembly. The control device is configured to determine a force exerted by the actuation device on the force sensor based on a measurement signal received from the at least one force sensor. The force sensors of the first sensor group are arranged one on top of another or adjacent to one another with respect to the actuation device.

Each force sensor is configured to ascertain the respective detected force electrically or electronically at the control device of the sensor assembly. Furthermore, the force sensors are not restricted to hydraulically based detection mechanisms. Therefore, a hydraulically based detection of the input commands of the driver with respect to the actuation device can be avoided. A weight savings and a reduction of the required installation space can thus be achieved.

In addition, a redundancy is provided, since the sensor assembly comprises at least two force sensors, wherein each of the force sensors is configured for detecting the force acting thereon. Therefore, the force exerted by the actuation device can in principle be determined based on each force sensor. The reliability of the sensor assembly is thus improved.

The force sensors are not restricted to specific types or to a specific mode of functioning. The force sensors can be active or passive. In general, a supply voltage is provided for active force sensors. For example, a force sensor can have a strain gauge which changes its resistance due to a compression or extension. Strain gauges enable a particularly significant reduction in installation space and a weight savings, since they have small intrinsic dimensions and a low intrinsic weight. At the same time, they provide a high level of precision with respect to the application of force.

Other types of force sensors can also be used, for example, force sensors having a piezoelectric or a piezoresistive material. Spring-based force sensors, electrodynamic force sensors, force sensors having an oscillating element, or force sensors having other types of resistive force pickups in addition to strain gauges can also be used.

The mechanical coupling between the at least one force sensor of the sensor group and the actuation device can also be indirect. This means that an intermediate component can be provided, which provides a mechanical coupling between the actuation device and the force sensor.

The actuation device is preferably a pedal, a steering wheel, or a joystick. The actuation device is configured to be actuated by a user of the vehicle in order to thus take influence on the vehicle configuration, in particular the driving behavior. In other words, the actuation device is configured to enable an input, desired by the driver, for the manipulation of the driving behavior of a vehicle and therefore to ensure an acceleration and/or braking and/or steering setting in accordance with the driver intention.

Since only one force sensor of the sensor group necessarily has to be coupled to the control device in order to transmit correspondingly detected measured values about the forces detected by the force sensors of the sensor group, a communication can also be provided between the force sensors. The force sensors are therefore not restricted in the present case such that they only have force pickups. Rather, they can also have communication devices.

The electrical or electronic coupling between the at least one force sensor of the sensor group and the control device can be ensured, for example, with the aid of signal lines. Alternatively, wireless communication mechanisms can also be used in order to transmit the forces detected by the force sensors to the control device.

Force sensors arranged one on top of another can be viewed as arranged in series (series arrangement). This means that a force caused by the actuation device is initially exerted on a first force sensor, which is arranged adjacent to the actuation device. The force is then exerted originating from the first force sensor on the second force sensor arranged one on top of another with the first force sensor. The force detection by the first force sensor therefore does not influence the force originally caused by the actuation device. This means that the forces acting on the first force sensor and the second force sensor are equal. To achieve this, the force sensors can each have correspondingly suitable mechanical components, for example, a cantilever arm or a cantilever. The force which acts on a specific force sensor can thereby similarly be conveyed by this force sensor to a further force sensor arranged one on top of another with this force sensor.

Optionally, for a sensor group which has force sensors arranged one on top of another, all force sensors arranged one on top of another are coupled with the control device. This means that with force sensors arranged one on top of another, each of the force sensors transmits the force detected thereby to the control device.

Force sensors arranged adjacent to one another can be viewed as arranged parallel to one another (parallel arrangement). This means that a force caused by the actuation device is distributed on the force sensors arranged adjacent to one another in accordance with a predetermined ratio. Partial forces are thus detected in each case which together result in the total force caused by the actuation device. The sensor assembly can have a corresponding device for allocating the force caused by the actuation device. The device can ensure the allocation of the force caused by the actuation device corresponding to a predetermined ratio with respect to the force sensors arranged adjacent to one another.

Optionally, for a sensor group which has force sensors arranged adjacent to one another, at least one of the force sensors is coupled with the control device.

Optionally, the sensor group can have further force sensors. The additional force sensors can also ensure the coupling to the control device with respect to force sensors arranged adjacent to one another.

The control device is preferably configured in order to take the respective topology (series arrangement or parallel arrangement) of the sensor assembly into consideration in the determination of the force caused by the actuation device. This means that the control device can take into consideration whether and to what extent force sensors of the sensor assembly are arranged one on top of another and/or adjacent to one another with respect to the actuation device. For example, with force sensors arranged adjacent to one another, the ratio of the division of the force acting on the force sensors arranged adjacent to one another can be taken into consideration.

The control device is preferably coupled with a storage device, in which information about the topology of the sensor assembly (assemblies) is stored. This information can be taken into consideration by the control device, in order to precisely determine the force exerted by the actuation device.

The sensor assembly optionally has a second sensor group. At least one force sensor of the second sensor group is mechanically coupled with the actuation device and at least one force sensor of the second sensor group is electrically or electronically coupled with the control device. The force sensors of the second sensor group are arranged one on top of another or adjacent to one another with respect to the actuation device. The redundancy with respect to the detection of the force caused by the actuation device is further improved by the second sensor group. The reliability is thus increased.

Force sensors arranged adjacent to one another are preferably mechanically coupled with one another by a balance beam. The force sensors arranged adjacent to one another are mechanically coupled with one another by the balance bar. An allocation of the force acting on the entirety of the force sensors adjacent to one another can therefore be ensured particularly reliably by the balance bar.

The balance bar is optionally fundamentally not restricted to the use of only two force sensors coupled with the balance bar. The balance bar can also enable an allocation of a force onto more than two force sensors arranged adjacent to one another.

The balance bar particularly preferably ensures a force allocation in the ratio 1:1 onto two force sensors arranged adjacent to one another. Both force sensors are thus equally subjected to and strained by the force. Furthermore, the determination of the force exerted by the actuation device is thus particularly simple.

With more than two force sensors arranged adjacent to one another, an allocation of 1:n per force sensor can optionally take place due to the balance bar. The number of the force sensors arranged adjacent to one another with respect to the balance bar is n in this case. The total force absorbed by the balance bar is thus allocated in partial forces of equal size.

In some embodiments, the sensor assembly has sufficiently many force sensors which are arranged such that the control device of the sensor assembly receives measurement signals from at least two force sensors. The control device is then configured to determine whether the received measurement signals are corresponding with one another.

Since in a single sensor group having force sensors arranged one on top of another, each of the force sensors is coupled with the control device, two measurement signals for the control device are already provided by two force sensors arranged one on top of another. Insofar multiple sensor groups are not necessarily required so that the control device receives at least two measurement signals.

Alternatively, the sensor assembly can also comprise two sensor groups of force sensors arranged adjacent to one another in each case, since each group of force sensors arranged adjacent to one another transmits at least one measurement signal to the control device.

According to a further alternative, the sensor assembly can also have a first sensor group of force sensors arranged one on top of another and a second sensor group of force sensors arranged adjacent to one another, by which at least three measurement signals are transmitted to the control device.

The sensor assembly can also be expanded arbitrarily with respect to the comprised sensor group or sensor groups. It is solely decisive that at least two measurement signals are received by the control device. The control device can then determine whether the received measurement signals are corresponding to one another. For example, with force sensors arranged one on top of another, it can be determined whether the measurement signals received from the respective force sensors reflect forces of equal size.

Optionally, the control device is configured to determine a signal difference between received measurement signals in consideration of one or more topology (topologies) of the respective sensor group(s) and to compare it to a difference threshold value. This means that the control device has information available, for example, by way of topology data stored in a storage device about the respective sensor group(s), how various measurement signals are to be set in relation to one another. In other words, the control device knows whether a measurement signal reflects a configuration of force sensors arranged adjacent to one another or one on top of another or mixed forms thereof. Therefore, the control device can evaluate received measurement signals at least in pairs and determine a signal difference between the measurement signals. The signal difference is compared with a difference threshold value in order to judge the possibility of the received signals. The redundancy of the sensor assembly with respect to the determination of the force caused by the actuation device is thus improved.

The control device of the sensor assembly is preferably configured, in order in dependence on the comparison between the signal difference and the difference threshold value,
to transmit a force signal to a motor control device, a brake control device, or a steering control device of the vehicle, and/or
to trigger a fault mode of the vehicle.

If the signal difference between the received measurement signals, in consideration of the topologies of the respective sensor groups, is less than the difference threshold value, the control device can presume that the received signals are corresponding with one another. As a result, the force caused by the actuation device can be determined from the measurement signals and transmitted as a force signal to a motor control device, a brake control device, or a steering control device of the vehicle, depending on whether it is an actuation device which is intended for influencing the driving behavior, the braking behavior, or the steering behavior of the vehicle or combinations thereof. For example, for an accelerator pedal, the force signal is transmitted to a motor control device, while for a brake pedal, the force signal is transmitted to a brake control device. For a steering angle specification device, for example, a steering wheel, a force signal is transmitted to the steering control device. As a result, the vehicle can thus be controlled by the motor control device, the brake control device, or the steering control device or combinations thereof in accordance with the input of the driver by the actuation device.

The actuation device can thus comprise at least one gas pedal and/or one brake pedal and/or one steering angle specification device, for example, a steering wheel.

If the signal difference between at least two of the received measurement signals, in consideration of the topologies of the respective sensor groups, is greater than the difference threshold value, the control device thus has to presume that the received signals are not corresponding with one another. This indicates an error state of the sensor assembly. As a result, a fault mode of the vehicle can thus be triggered. Additionally, a corresponding force signal can also nonetheless optionally be transmitted here to the motor control device, the brake control device, or the steering control device of the vehicle, wherein the transmission comprises information, however, about measurement signals at least partially not corresponding to one another being present. Optionally, the triggering of the fault mode of the vehicle can be carried out by the motor control device, the brake control device, or the steering control device in consideration of further data about the respective vehicle configuration of the vehicle.

The control device is particularly preferably configured, in the fault mode
to limit a power output of an electrical machine of the vehicle, and/or
to activate an emergency braking device of the vehicle, and/or
to trigger an output of a message about the fault mode to at least one output device of the vehicle; and/or
to trigger a safety protocol, wherein after triggering of the safety protocol, an adapted force signal is output to the motor control device.

The adapted force signal can be such that, for example, in the case of an accelerator pedal (gas pedal) of the vehicle, a damping term is taken into consideration. This means that the output force signal is adapted such that it reflects a delayed and/or reduced force which is exerted by the actuation device.

Additionally or alternatively, the adapted force signal can be such that, due to the safety protocol, a consideration of signals detected by a surroundings sensor system is triggered by the motor control device, the brake control device, or the steering control device of the vehicle. The corresponding motor control device, the brake control device, or the steering control device can then access further sensors, such as radar, cameras, lidar, ultrasound, or the like in order to ensure safe stopping of the vehicle. Furthermore, for the case of autonomous driving, sensor signals of such sensors can be taken into consideration in order to perform an assessment with respect to other road users.

The safety protocol insofar reflects a predetermined stopping strategy which can be triggered in the fault mode.

The safety protocol can also comprise a steering strategy, which includes and ensures evading or driving around obstacles. An adapted steering signal can then be output to a steering control device, by which the steering actuator ensures a deflection of wheels of the vehicle in accordance with the steering strategy.

This means that the control device can adopt a higher-order functionality after recognition of a fault mode due to measurement signals not corresponding with one another with respect to the vehicle control. The control device of the sensor assembly can thus then exert a master function. As a result, a speed reachable by the vehicle can be limited due to the reduced power output. Alternatively, the vehicle can also be brought to a standstill or a message can be triggered for the user of the vehicle about a malfunction of the sensor assembly and thus of the force detection existing.

The described functionalities of the control device can also be dependent, for example, on the signal difference determined by the control device being set in relation to different difference threshold values. For example, emergency braking of the vehicle can be triggered if the signal difference determined by the control device exceeds a particularly high difference threshold value, whereas the vehicle can still be usable with a reduced power if the signal difference exceeds a comparatively low difference threshold value.

With respect to the one difference threshold value or the multiple difference threshold values, a hysteresis can be provided, in order to enable a stable regulation behavior.

Optionally, at least one sensor group has at least one third force sensor, which is arranged one on top of another or adjacent to one another with at least one further force sensor of the respective sensor group with respect to the actuation device.

Particularly preferably, at least one sensor group has at least one further force sensor, which is arranged one on top of another or adjacent to one another with at least one further force sensor of the respective sensor group with respect to the actuation device.

For example, for force sensors of a sensor group arranged adjacent to one another, an additional force sensor can be provided which is arranged one on top of another with both force sensors arranged adjacent to one another. In this case, the measurement signal of this sensor group can only be provided by the additional force sensor for the control device, which is arranged one on top of another with the respective force sensors arranged adjacent to one another.

The control device of the sensor assembly preferably has at least one data processing device. The determination of the force exerted by the actuation device can insofar in particular be executed in a computer-implemented manner as described above. Moreover, the check with respect to the correspondence between the received measurement signals by the control device can be executed in a computer-implemented manner.

According to a further aspect, a computer program product is also provided which has commands which, upon execution by a data processing device of the control device, cause it to carry out the evaluation of the at least one measurement signal as described above.

Furthermore, according to a further aspect, a storage medium is also provided which has the computer program product as described above, so that upon execution by a data processing device of the control device, it causes it to carry out the evaluation of the at least one measurement signal as described above.

According to a further aspect, a vehicle is also provided. The vehicle has at least one actuation device, a motor control device, a brake control device, or a steering control device and a sensor assembly as described above. The force exerted by the actuation device is determinable by the sensor assembly. The control device of the sensor assembly is configured to transmit the determined force of the actuation device by a force signal to the motor control device, the brake control device, or the steering control device of the vehicle. Whether the force signal is transmitted to the motor control device or the brake control device is dependent on whether the actuation device is configured for influencing the acceleration behavior, the braking behavior, or the steering behavior of the vehicle, for example, whether it is an accelerator pedal or a brake pedal of the vehicle.

The vehicle thus configured enables, with respect to the user input by the respective actuation device, a reduction of the required installation space and a savings in weight, since the force sensors of the sensor assembly are not restricted to hydraulic pickups. In particular, the operating efficiency of the vehicle measured on the available amount of energy is improved by the savings in weight.

Optionally, the vehicle can be an at least partially electrically driven vehicle.

Alternatively thereto, the vehicle can also be driven by an internal combustion engine.

In the meaning of the present disclosure, vehicles can in particular comprise land vehicles, namely, among other things, electric scooters, E-scooters, two-wheeled vehicles, motorcycles, three-wheeled vehicles, tricycles, quads, off-road and road vehicles such as passenger vehicles, buses, trucks, tractors, and other utility vehicles, rail vehicles (railways), which have at least one electric motor used to propel the vehicle. Vehicles can be manned or unmanned. In addition to solely electric vehicles (BEV), plug-in hybrids (PHEV) and fuel cell vehicles (FCEV) can also be comprised.

The present disclosure and further advantageous embodiments and refinements thereof are described and explained in more detail hereinafter on the basis of the examples shown in the drawings. The features which can be inferred from the description and the drawings can be applied according to the present disclosure individually as such or in groups in any combination.

### BRIEF DESCRIPTION OF THE DRAWINGS

FIG. 1 shows a schematic representation of a sensor assembly according to the present disclosure having force sensors arranged one on top of another and an actuation device,

FIG. 2 shows a schematic representation of a sensor assembly according to the present disclosure having force sensors arranged one on top of another and an actuation device, and

FIG. 3 shows a schematic representation of a vehicle according to the present disclosure having a sensor assembly.

### DETAILED DESCRIPTION OF THE DRAWINGS

All features disclosed hereinafter with respect to the exemplary embodiments and/or the accompanying figures can be combined alone or in any sub combination with features of the aspects of the present disclosure, including features of preferred embodiments, presuming the resulting feature combination is reasonable for a person skilled in the art in the area of the technology.

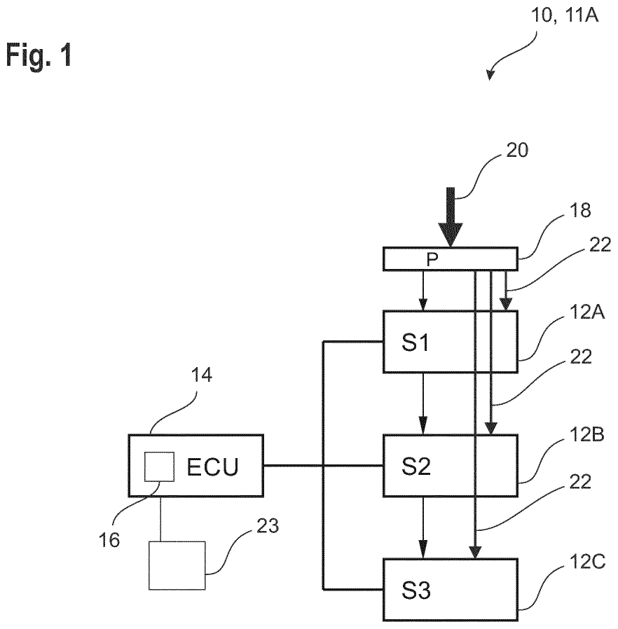

FIG. 1 shows a schematic representation of a sensor assembly 10 having force sensors 12 arranged one on top of another and an actuation device 18. The actuation device 18 is a pedal in the present case. The sensor assembly 10 can also be used in conjunction with other actuation devices 18, however, for example, a steering wheel, a joystick, or the like. In general, the actuation device 18 is configured to enable an input desired by the driver for the manipulation of the driving behavior of a vehicle.

According to this embodiment, the sensor assembly 10 comprises a sensor group 11A having three force sensors 12A, 12B, 12C. The force sensors 12 of the sensor group 11A are arranged one on top of another. This means that the second force sensor 12B is arranged adjacent to the first force sensor 12A, and that the third force sensor 12C is arranged adjacent to the second force sensor 12B. The three force sensors 12 thus form a series arrangement.

In the present case, the sensor group 11A of the sensor assembly 10 does comprise three force sensors 12, but in general the sensor group 11A only has to have two force sensors 12. The third force sensor 12 is optional.

The sensor assembly 10 furthermore comprises a control device 14, which has a data processing device 16.

Since the force sensors 12 of the sensor group 11A are arranged in accordance with a series arrangement, each of the force sensors 12 is electrically coupled with the control device 14. Each of the force sensors 12 can thus transmit a force detected thereby to the control device 14 by a corresponding signal.

The sensor assembly 10 is configured for use with the actuation device 18. The actuation device 18 is generally configured to be subjected to an input force 20 by a user and as a result to be deflected. Due to the deflection of the actuation device 18, a force 22 is exerted by the actuation device 18, the pedal here, on the sensor assembly 10.

Since the force sensors 12 of the sensor group 11A are positioned in accordance with a series arrangement in the present case, the force 22 is initially exerted on the first force sensor 12A in the present case, which is arranged adjacent to the actuation device 18 and is mechanically coupled therewith. The force sensors 12 are configured such that they convey the force to which they are subjected uninfluenced further to following mechanically coupled force sensors 12. The force 22 exerted by the actuation device 18 is therefore similarly exerted on the second force sensor 12B and the third force sensor 12C.

As a result, all force sensors 12 detect an equal force acting on each of them. The force exerted by the actuation device 18 is not divided into partial forces.

The control device 14 is configured to determine a force 22 exerted by the actuation device 18 based on a received measurement signal. A measure of the input force 20 exerted on the actuation device 18 by a user input is provided by the determination of the force 22 exerted by the actuation device 18.

In the present case, the control device 14 is coupled with a storage device 23, which comprises information about the topology of the force sensors 12 in accordance with the series arrangement. The control device 14 thus receives information in the present case about how the received measurement signal is to be evaluated to determine the force 22 exerted by the actuation device 18.

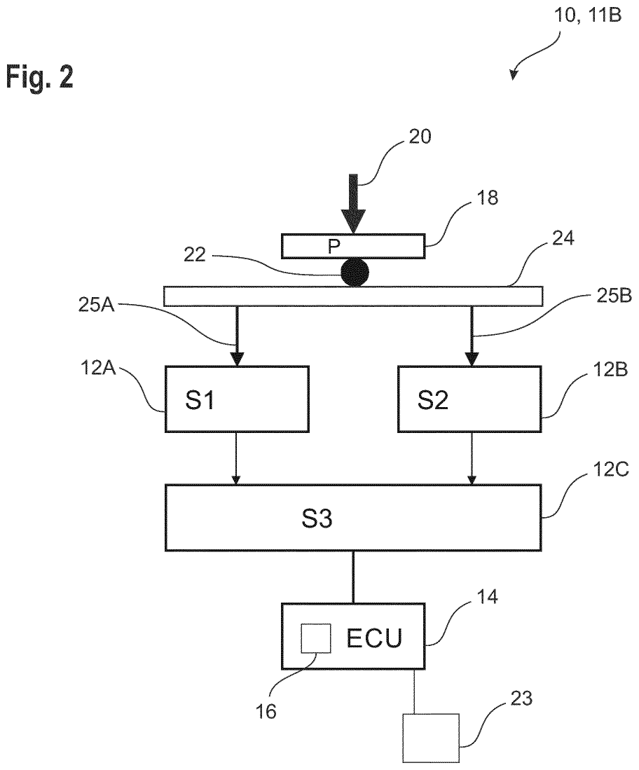

FIG. 2 shows a schematic representation of a sensor assembly 10 having force sensors 12 arranged one on top of another and an actuation device 18. Only the differences from the sensor assembly 10 of the preceding figure will be described here.

In contrast to the sensor group 11A of the sensor assembly 10, which is shown in the preceding figure, the sensor group 11B of the sensor assembly 10 shown here has force sensors 12A, 12B arranged adjacent to one another. This means that according to the sensor group 11B, the first force sensor 12A and the second force sensor 12B are arranged adjacent to one another with respect to the actuation device 18. They are thus positioned in accordance with a parallel arrangement with respect to the actuation device 18.

To ensure an allocation of the force 22 exerted by the actuation device 18, in the present case the sensor assembly 10 has a balance bar 24. By the balance bar 24, the force 22 exerted by the actuation device 18 is allocated into partial forces 25A, 25B. The partial forces 25A, 25B each act individually on one of the force sensors 12A, 12B, which are mechanically coupled with the balance bar 24.

In the present case, the sensor group 11B of the sensor assembly 10 moreover comprises a third force sensor 12C, which is arranged one on top of another with respect to the first force sensor 12A and the second force sensor 12B. This means that the forces conveyed by the force sensors 12A, 12B act jointly on the mechanically coupled third force sensor 12C. The partial forces 25A, 25B add up with respect to the third force sensor 12C.

In the present case, the third force sensor 12C is coupled with the control device 14 of the sensor assembly 10.

However, the third force sensor 12C is optional with respect to the sensor group 11B. Instead of the third force sensor 12C, one of the first force sensor 12A and the second force sensor 12B or both of them can optionally also be coupled with the control device 14.

The control device 14 is again configured to determine a force 22 exerted by the actuation device 18 based on a measurement signal. For this purpose, the control device 14 can use topology data which are stored in the storage device 23.

Optionally, the sensor assembly 10 can comprise further force sensors 12. The sensor assembly 10 can also have multiple sensor groups 11A, 11B of identical or different topology (series arrangement, parallel arrangement). In general, the sensor assembly 10 only comprises a single control device 14, however.

A redundancy with respect to the force 22 exerted by the actuation device 18 is provided by the use of a plurality of force sensors 12.

Optionally, the sensor assembly 10 is such that the control device 14 receives at least two measurement signals. The sensor assembly 10 is then such that it can compare the measurement signals with one another and can determine a signal difference between the received measurement signals. The respective topology of the sensor groups 11A, 11B is taken into consideration here, for example, by way of topology data which are stored in the storage device 23.

The control device 14 is configured to view two measurement signals as corresponding to one another in pairs if the signal difference between them is less than a predetermined difference threshold value, wherein the topologies of the participating sensor groups 11A, 11B are taken into consideration. Meeting a correspondence criterion can be a condition for a force signal for a motor control device, a brake control device, or a steering control device to be provided by the control device 14 in order to enable the control of a vehicle.

If the predetermined difference threshold value is exceeded by the signal difference, a fault mode of the vehicle can be triggered by the control device 14.

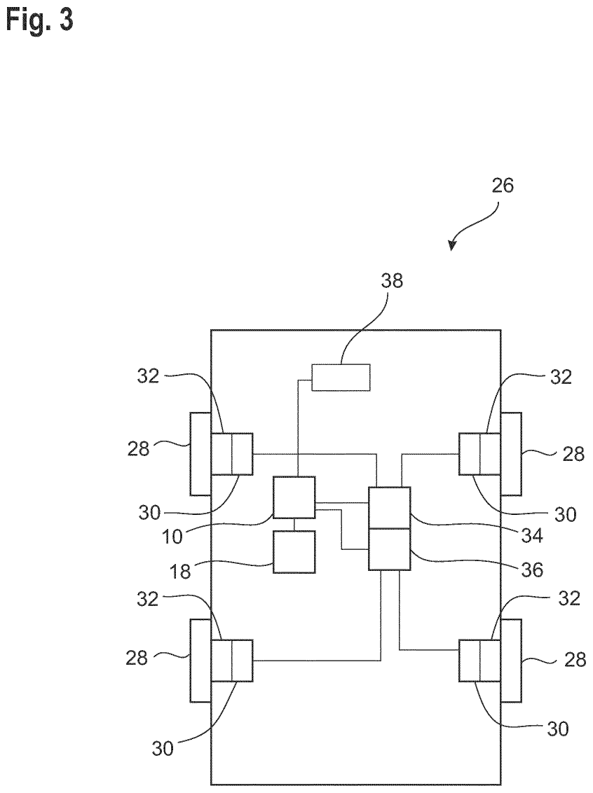

FIG. 3 shows a schematic representation of a vehicle 26 having a sensor assembly 10.

The sensor assembly 10 is coupled with an actuation device 18.

The vehicle 26 has wheels 28, to each of which an electric machine 30 and a braking device 32 are assigned. The electric machines 30 are coupled with a motor control device 34. The braking devices 32 are coupled with a brake control device 36.

The sensor assembly 10 is coupled with the motor control device 34 or with the brake control device 36, depending on whether the actuation device 18, the pedal here, is an accelerator pedal or a brake pedal of the vehicle 26. In particular, the control device 14 of the sensor assembly 10 is coupled with the motor control device 34 or the brake control device 36.

In an alternative embodiment, the sensor assembly 10 can also be coupled with an actuation device 18, which comprises a steering angle specification device for the driver, for example, a steering wheel of the vehicle 26. The steering angle specification device is then coupled with a steering control device, which regulates the deflection of the wheels 28 by a steering actuator. If the actuation device 18 is a steering angle specification device of the driver, the steering angle intention can be detected in accordance with the deflection of the actuation device 18 in relation to a reference point by the sensor assembly 10. The wheels 28 can then be deflected in accordance with the steering angle specification of the driver by assigned steering actuators.

Alternatively, the deflection of the wheels 28 in accordance with the steering angle specification of the driver can also be ensured if the wheels 28 are coupled with an actuator using a mechanical connection as is typical in current vehicles.

The sensor assembly 10 is furthermore coupled with an output device 38.

After completed determination of the force 22 exerted by the actuation device 18, a corresponding force signal is output by the control device 14 of the sensor assembly 10 to the motor control device 34, the brake control device 36 (or the steering control device), depending on whether the pedal of the actuation device 18 is an accelerator pedal, a brake pedal, or a steering angle specification device of the vehicle 26. The motor control device 34, the brake control device 36 (or the steering control device) can control the vehicle 26 in accordance with the input of a user by way of the force signal.

If a fault mode is recognized by the control device 14 of the sensor assembly 10, the sensor assembly 10 can thus output a corresponding corrective signal to the motor control device 34 and/or the brake control device 36, which triggers the fault mode of the vehicle 26. In this case, for example, the power outputs provided by the electric machines 30 can be limited by the motor control device 34.

Alternatively, the brake control device 36 can be configured by a corresponding corrective signal to trigger an emergency braking process of the vehicle 26 by the braking devices 32.

Furthermore, a corresponding message about the fault mode of the vehicle 26 can be provided for a user of the vehicle 26 by the sensor assembly 10 by the output device 38.

In the present application, reference can be made to quantities and numbers. If not expressly indicated, such quantities and numbers are not to be viewed as restrictive, but rather as examples of the possible quantities or numbers in conjunction with the present application. In this context, the term “plurality” can also be used in the present application to refer to a quantity or number. In this context, the term “plurality” means any number which is greater than one, for example, two, three, four, five, etc. The terms “approximately”, “about”, “near” etc. mean plus or minus 5% of the specified value.

1-10. (canceled)

11. A sensor assembly for an actuation device of a vehicle comprising:
at least one control device; and
a first sensor group having a first force sensor and a second force sensor,
wherein at least one of the first and/or second force sensors is mechanically coupled with the actuation device, and at least one of the first and/or second force sensors is electrically coupled with the control device,
wherein each of the first and second force sensors is configured to detect a force acting on the respective force sensor independently of other force sensors of the sensor assembly,
wherein the control device is configured to determine a force exerted by the actuation device on each respective force sensor based on a measurement signal received from the respective force sensor, and
wherein the first and second force sensors of the first sensor group are arranged one on top of another or adjacent to one another with respect to the actuation device.

12. The sensor assembly according to claim 11, comprising:
a second sensor group,
wherein at least one force sensor of the second sensor group is mechanically coupled with the actuation device and at least one force sensor of the second sensor group is electrically coupled with the control device, and
wherein the force sensors of the second sensor group are arranged one on top of another or adjacent to one another with respect to the actuation device.

13. The sensor assembly according to claim 11,
wherein the force sensors are arranged adjacent to one another and are mechanically coupled with one another by a balance bar.

14. The sensor assembly according to claim 13,
wherein the balance bar is configured to ensure a force allocation in a of ratio 1:1 on the force sensors arranged adjacent to one another.

15. The sensor assembly according to claim 11,
wherein the sensor assembly comprises a plurality of force sensors that are arranged such that the control device receives measurement signals from at least two force sensors, and wherein the control device is configured to determine whether the received measurement signals are corresponding with one another.

16. The sensor assembly according to claim 15,
wherein the control device is configured to determine a signal difference between received measurement signals in consideration of topologies of the first sensor group and at least one other sensor group to compare the signal difference to a difference threshold value.

17. The sensor assembly according to claim 16,
wherein in that the control device is configured to, depending on the comparison between the signal difference and the difference threshold value:
transmit a force signal to a motor control device, a brake control device, or a steering control device of the vehicle; and/or
trigger a fault mode of the vehicle.

18. The sensor assembly according to claim 17,
wherein the control device is configured to, in the fault mode:
limit a power output of an electric machine of the vehicle;
activate an emergency braking device of the vehicle;
trigger an output of a message about the fault mode at at least one output device of the vehicle; and/or
trigger a safety protocol, wherein after triggering of the safety protocol, an adapted force signal is output to the motor control device, the brake control device, or the steering control device.

19. The sensor assembly according to claim 11,
wherein the first sensor group comprises at least a third force sensor that is arranged one on top of another or adjacent to one another with at least one further force sensor of the respective sensor group with respect to the actuation device.

20. A vehicle comprising:
the actuation device comprising a pedal;
the motor control device, the brake control device, and/or the steering control device; and
the sensor assembly according to claim 11,
wherein the force exerted by the actuation device is determinable by the sensor assembly, and wherein the control device of the sensor assembly is configured to transmit the determined force of the actuation device by a force signal to the motor control device and/or the brake control device and/or the steering control device of the vehicle.
